(19) United States
(12) Patent Application Publication
(10) Pub. No.: US 2017/0147707 A1
(43) Pub. Date: May 25, 2017

(54) APPARATUS AND METHOD FOR MANAGING GRAPH DATA

(71) Applicant: ELECTRONICS AND TELECOMMUNICATIONS RESEARCH INSTITUTE, Daejeon (KR)

(72) Inventor: Hyung-Kyu LEE, Daejeon (KR)

(73) Assignee: ELECTRONICS AND TELECOMMUNICATIONS RESEARCH INSTITUTE, Daejeon (KR)

(21) Appl. No.: 15/228,113

(22) Filed: Aug. 4, 2016

(30) Foreign Application Priority Data
Nov. 23, 2015 (KR) 10-2015-0164303

(51) Int. Cl. G06F 17/30

(52) U.S. Cl. CPC G06F 17/30958; G06F 17/30994; G06F 17/30979

(57) ABSTRACT

The disclosure relates to an apparatus for managing graph data including a data analyzing unit configured to analyze a graph data set to extract analysis information including relationship between graph data; a memory configured to store the analysis information; and a scheduler configured to determine a storage location where the graph data is to be stored in a database based on the analysis information.

### CROSS REFERENCE TO RELATED APPLICATION

This application claims the benefit under 35 U.S.C. §119(a) of Korean Patent Application No. 10-2015-0164303 filed on Nov. 23, 2015 in the Korean Intellectual Property Office, the entire disclosure of which is incorporated herein by reference for all purposes.

### BACKGROUND

1. Technical Field

The following description relates to a technology for managing graph data and more particularly, to a technology for efficiently storing and searching graph data.

2. Description of Related Art

Graph data is generally a data set of one of more triples of which each consists of a subject, a predicate, and an object. The data set has a very complex interconnected data model. Thus, large-scale graph data requires big storage capacity and further requires bigger as computing performance is more desired for services. It is very difficult to build a system which can efficiently store and search data having complex inter-relationship therebetween through databases.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, an apparatus for managing graph data includes a data analyzing unit configured to analyze a graph data set to extract analysis information including relationship between graph data; a memory configured to store the analysis information; and a scheduler configured to determine a storage location where the graph data is to be stored in a database based on the analysis information.

The scheduler may determine the storage location to store the graph data within a range of threshold relationship in physically one storing device.

The relationship may be determined based on hop distance between graph data.

The apparatus for managing graph data may further include a data pre-processing unit configured to convert input data to graph data.

The apparatus for managing graph data may further include a key calculating unit configured to generate a key including index information to search the graph data stored in the database.

The apparatus for managing graph data may further include a data searching unit configured to return a result value by searching the graph data stored in the database when a query is inputted.

The graph data may be RDF-typed data.

The RDF type may be a triple structure of a subject, a predicate and an object, and the database may store the graph data in a subject-table, a predicate-table and an object-table.

The apparatus for managing graph data may further include a searching unit configured to search the graph data corresponding to a query from the database based on the key to return a result value when the query is inputted.

The data searching unit may include a query analyzing unit configured to parse the inputted query in SQL and analyze the parsed SQL.

According to another general aspect, a method for managing graph data includes analyzing a graph data set and extracting analysis information including relationship between graph data; storing the analysis information in a memory; and determining a storage location where the graph data is to be stored in a database based on the analysis information.

The determining a storage location may include determining a storage location to store the graph data within a range of threshold relationship in physically one storing device.

The relationship may be determined based on hop distance between graph data.

The method for managing graph data may further include converting input data to graph data.

The method for managing graph data may further include generating a key including index information to search the graph data stored in the database.

The method for managing graph data may further include searching the graph data stored in the database to return a result value when a query is inputted.

The graph data may be RDF-typed data.

The RDF type may be a triple structure of a subject, a predicate and an object, and the database may store the graph data in a subject-table, a predicate-table and an object-table.

The method for managing graph data may further include searching the graph data corresponding to a query from the database based on the key to return a result value when the query is inputted.

The searching unit may include a query analyzing unit configured to parse the inputted query in SQL and analyze the parsed SQL.

### BRIEF DESCRIPTION OF DRAWNIGS

Hereinafter, the following description will be described with reference to embodiments illustrated in the accompanying drawings. To help understanding of the following description, throughout the accompanying drawings, identical reference numerals are assigned to identical elements. The elements illustrated throughout the accompanying drawings are mere examples of embodiments illustrated for the purpose of describing the following description and are not to be used to restrict the scope of the following description.

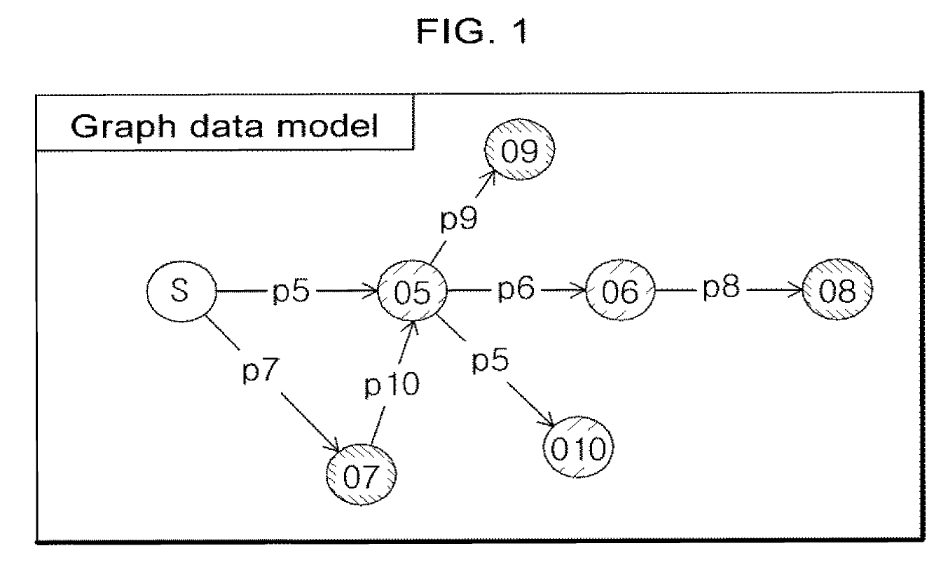

FIG. 1 is a diagram illustrating an example of a graph data model.

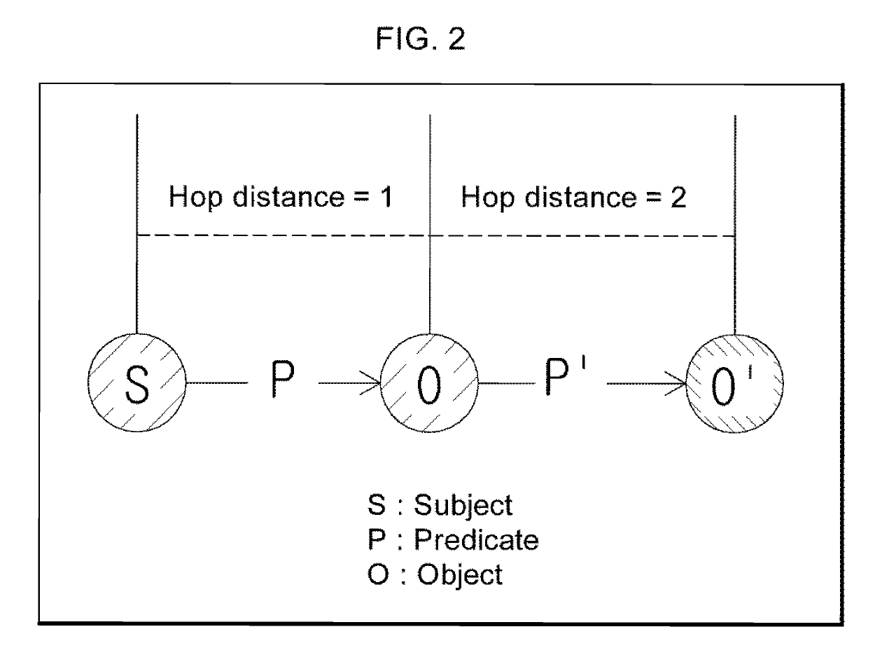

FIG. 2 is a diagram illustrating an example of hop distance of graph data sets.

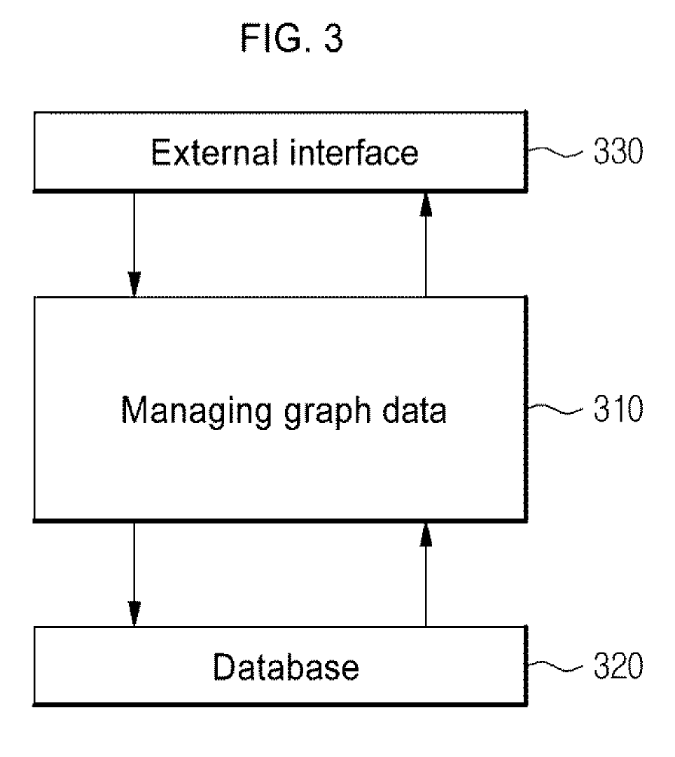

FIG. 3 is a diagram illustrating an example of an apparatus for managing graph data.

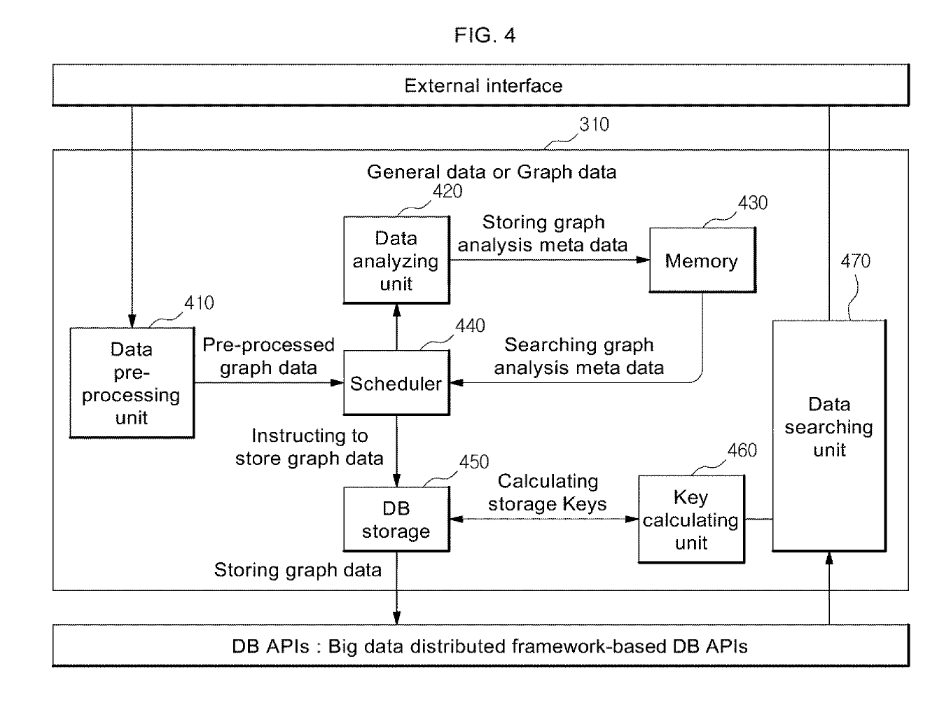

FIG. 4 is a block diagram illustrating an example of an apparatus for managing graph data.

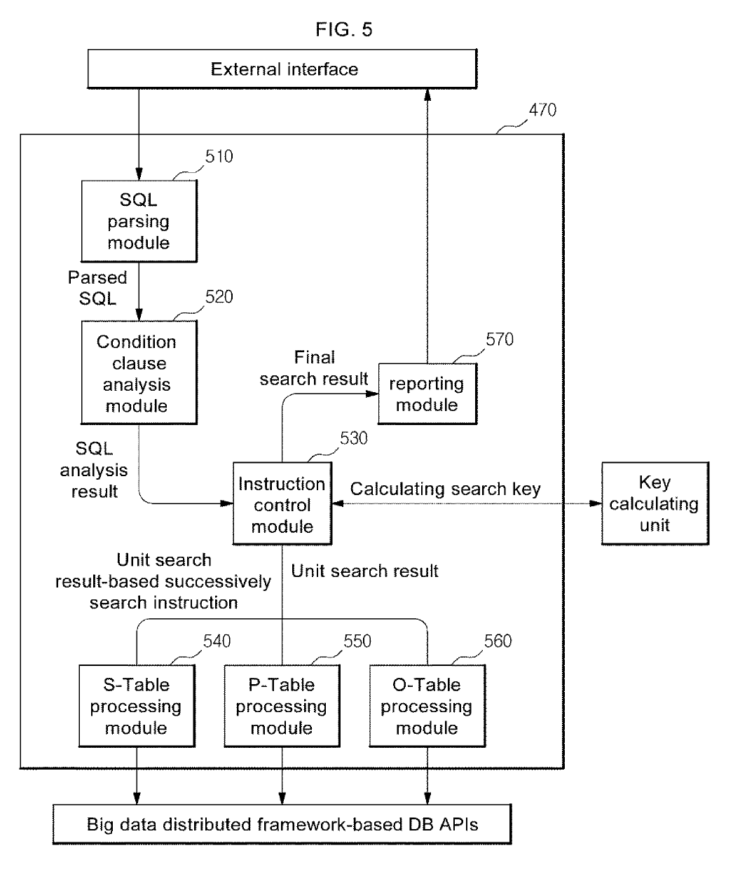

FIG. 5 is a diagram illustrating an example of a data searching unit.

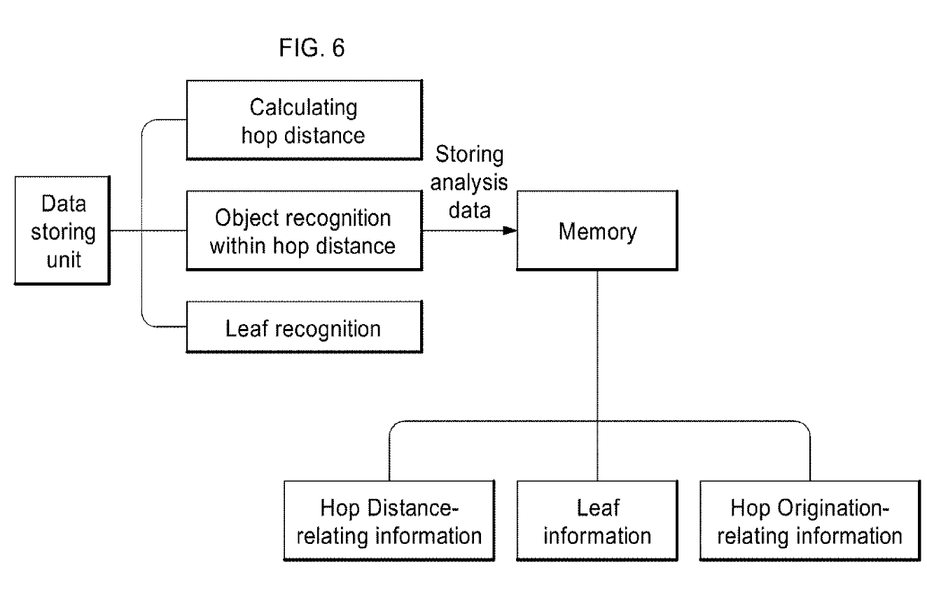

FIG. 6 is a diagram illustrating an example of explaining data, an analyzing unit and a memory.

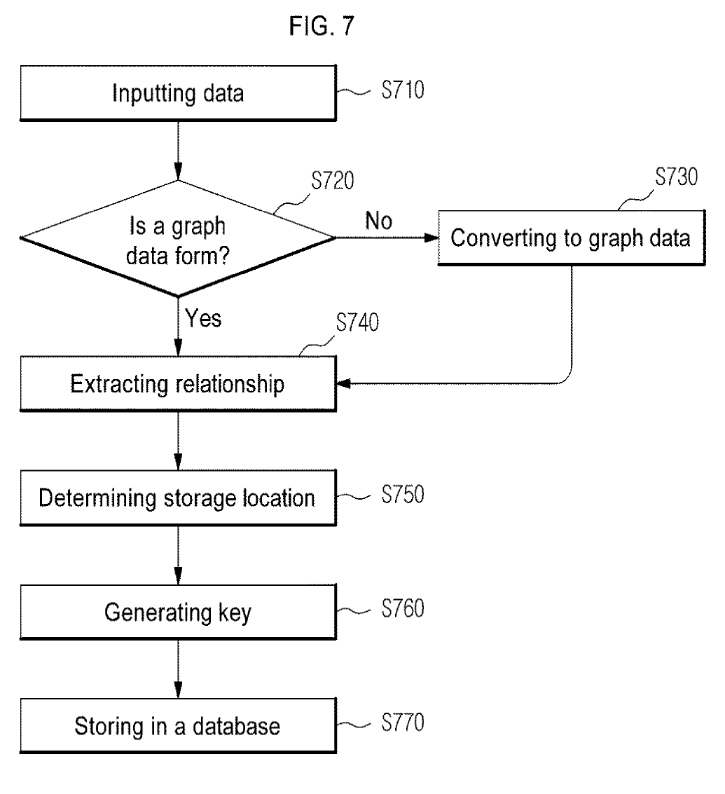

FIG. 7 is a flow chart illustrating an example of a method for storing graph data.

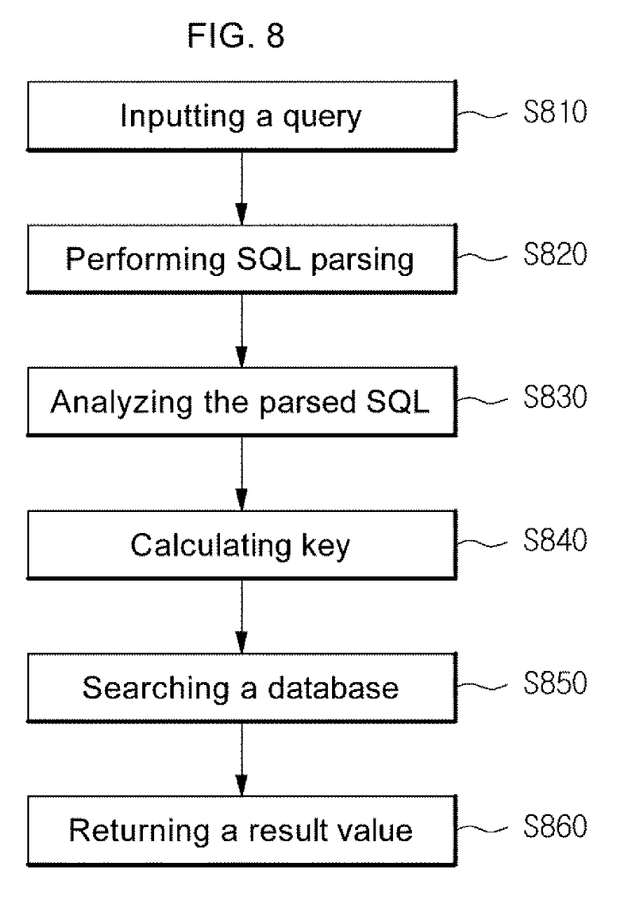

FIG. 8 is a flow chart illustrating an example of a method for searching graph data.

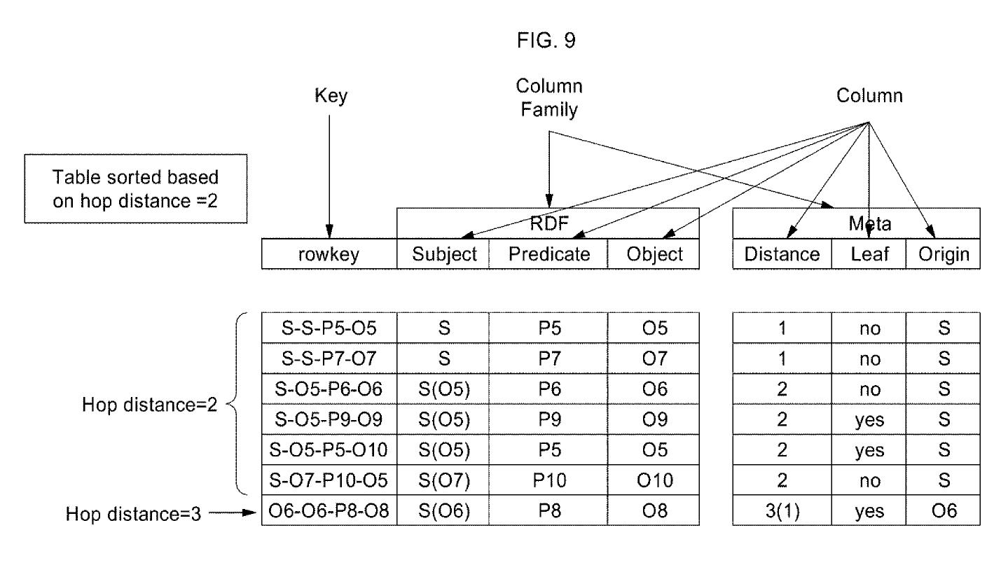

FIG. 9 to FIG. 11 are diagrams illustrating examples of tables of graph data which is stored in databases.

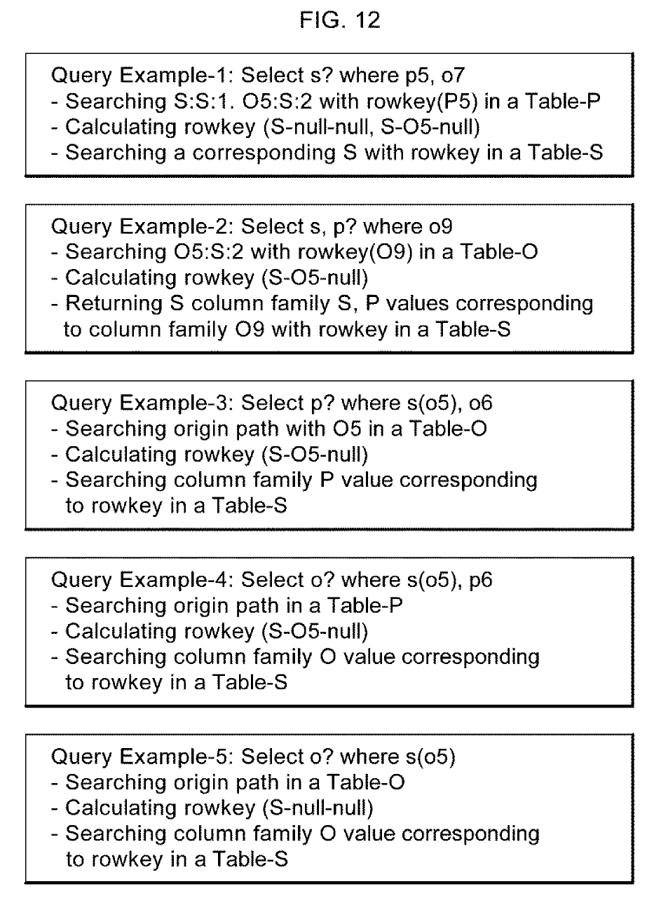

FIG. 12 is a diagram illustrating an example of searching graph data.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

Since there can be a variety of permutations and embodiments of the following description, certain embodiments will be illustrated and described with reference to the accompanying drawings. This, however, is by no means to restrict the following description to certain embodiments, and shall be construed as including all permutations, equivalents and substitutes covered by the ideas and scope of the following description. Throughout the description of the present disclosure, when describing a certain technology is determined to evade the point of the present disclosure, the pertinent detailed description will be omitted. Unless clearly used otherwise, expressions in the singular number include a plural meaning.

In descriptions of components of the disclosure, a different reference numeral may be assigned to the same component depending on the drawings, and the same reference numeral may be assigned to the same component in different drawings. However, neither of these means either that the component has a different function depending on embodiments or that the component has the same function in different embodiments. Functions of each component may be determined based on descriptions of each component in the embodiment.

FIG. 1 is a diagram illustrating an example of a graph data model.

Referring to FIG. 1, a graph data model consists of triple elements of a subject, a predicate, and an object as RDF (Resource Description Framework) data which is a standard representation format of semantic web.

FIG. 2 is a diagram illustrating an example of hop distance of graph data sets.

Referring to FIG. 2, O is in a 1 hop distance and O′ is in a 2 hop distance from S reference.

FIG. 3 is a diagram illustrating an example of an apparatus for managing graph data.

Referring to FIG. 3, an apparatus for managing graph data 310, a database 320 and an external interface 330 are illustrated.

The external interface 330 receives data and queries to transfer them to the apparatus for managing graph data 310.

The apparatus for managing graph data 310 analyzes the data received from the external interface 330 based on relationship thereof and stores the result in the database 320. The apparatus for managing graph data 310 also searches the database 320 when any query is received from the external interface 330 to return a result value corresponding to the query to the external interface 330.

The database 320 stores graph data.

In an embodiment, the database 320 may be a big data framework-based database such as HBase. The database 320 may also be a NoSQL-based database. Hbase is a NoSQL-based database that runs on Apache open source project and has a physical storage structure to generate tables in a distributed structure. Hbase may be also used for generating column-based data tables.

FIG. 4 is a block diagram illustrating an example of an apparatus for managing graph data.

Referring to FIG. 4, the apparatus for managing graph data 310 may include a data pre-processing unit 410, a data analyzing unit 420, a memory 430, a scheduler 440, a DB storage 450, a key calculating unit 460, and a data searching unit 470.

The data pre-processing unit 410 converts data inputted form an external interface to graph data. The data pre-processing unit 410 converts data inputted form an external interface to graph data when the inputted data is not graph data.

The data pre-processing unit 410 may convert the inputted data to graph data which can be processable in the apparatus for managing graph data 310 when the data is graph data but not processable in the apparatus for managing graph data 310.

In an embodiment, the graph data may be RDF(Resource Description Framework) data which is a standard representation format of semantic web.

In an embodiment, the graph data may be RDF data composed of triple elements of a subject, a predicate, and an object.

The data analyzing unit 420 analyzes the graph data to extract analysis information including relationship therebetween. In particular, the data analyzing unit 420 extracts relationship between graph data to store data having high degree of relationship to be close each other. Here, the relationship means logical interrelationship of data. For example, when first data and second data are read at the same time, the first data and the second data have high degree of relationship.

In an embodiment, the analysis information may include subject information, hop distance information, and hop original path information within a predetermined hop distance for each of a predicate or an object in a graph data model.

In an embodiment, the data analyzing unit 420 may extract relationship based on hop distance between data. An example for calculating a hop distance of the data analyzing unit 420 will be explained with reference to FIG. 1. The data analyzing unit 420 remembers a candidate group of O5 and O7 which can be h_dist=2 based on S for graph data set (S,P,O) to store data within a predetermined threshold hop distance (e.g., hop distance=2) to be adjacent with each other. The data analyzing unit 420 verifies the candidate group which is h_dist=2 when 3 graph data sets starting with O5 are realized. The data analyzing unit 420 also registers Objects of O6, O9, and O10 of Objects of O6, O9, and O10 as the candidate group which is h_dist=2. The data analyzing unit 420 verifies graph data sets starting with O6 as h_dist=3 since they are in a candidate group of h_dist=3. The data analyzing unit 420 also verifies O6 which is h_dist=3 as a new reference node. The data analyzing unit 420 stores reference node (S, O6 or the like) whenever it is generated to be searched rapidly when any query is inputted. The data analyzing unit 420 repeats the above process for the new reference node O6. The data analyzing unit 420 verifies O7 as a node which is h_dist=2 of S since O7 is in the h_dist=2 candidate group in which the reference node is S. The data analyzing unit 420 repeats the above process to store analysis information in the memory 430.

The memory 430 stores analysis result of the graph data. More particularly, the memory 430 stores continuously analysis results of data inputted to the apparatus for managing graph data 310.

The scheduler 440 determines storage location of the graph data. More particularly, the scheduler 440 determines storage location where the graph data is to be stored based on relationship between the graph data.

The scheduler 440 controls the overall operations of the apparatus for managing graph data 310. More particularly, the scheduler 440 transfers graph data to the data analyzing unit to analyze data, searches the analyzed information from the memory 430 to generate information to store the graph data in a S-Table, a P-Table, and an O-Table, and stores successively in the DB storage.

In an embodiment, the scheduler 440 determines storage location to store data having high degree of relationship to be adjacent with each other.

In an embodiment, the scheduler 440 determines storage location to store data having high degree of relationship in physically one storing device.

The DB storage 450 interfaces with the database.

The key calculating unit 460 generates keys including index information to search the graph data stored in the database. More particularly, the key calculating unit 460 generates keys to search the graph data stored in the database based on the analysis information.

In an embodiment, the kay consists of [Subject nodes in accordance with an order within a path from the reference Subject (S) node to (a predetermined hop distance-1) and current S, P, O nodes]. However, when a current S node is a reference Subject node, the Subject node on a path and the current S node are used duplicatedly as shown in FIG. 7.

The data searching unit 470 analyzes a query and searches graph data corresponding to the query from the database to return a result value. The data searching unit 470 will be explained in detail with reference to FIG. 5 below.

FIG. 5 is a diagram illustrating an example of a data searching unit.

Referring to FIG. 5, the data searching unit 470 may include a SQL parsing module 510, a condition clause analysis module 520, an instruction control module 530, a S-table processing module 540, a P-table processing module 550, an O-table processing module 560, and a reporting module 570.

The SQL parsing module 510 performs SQL parsing for an inputted query. More particularly, the SQL parsing module 510 parses an inputted query in SQL which is a form to search graph data stored in a database.

The condition clause analysis module 520 analyzes the parsed SQL. The condition clause analysis module 520 lets the instruction control module 530 determine search procedure of the S-table, the P-table, and the O-table through analysis of condition clauses of the parsed SQL.

The instruction control module 530 determines search procedure of each graph data stored in the S-table, the P-table, and the O-table based on the analyzed condition clauses and controls search instruction to generate a result value corresponding to the query by using or combining results searched according to the determined procedure. The instruction control module 530 may search the graph data stored in the database by using the key generated by the key calculating unit 460.

The S-table processing module 540 searches the S-table of the database in accordance with the instruction control module 530.

The P-table processing module 550 searches the P-table of the database in accordance with the instruction control module 530.

The O-table processing module 560 searches the O-table of the database in accordance with the instruction control module 530.

The reporting module 570 returns a result value searched from the database to correspond to the query to the external interface.

FIG. 6 is a diagram illustrating an example of explaining data, an analyzing unit and a memory.

Referring to FIG. 6, the data analyzing unit 420 transfers analysis information, which is analyzed from the graph data, to the memory 430. Here, the memory 430 includes hop distance calculation information, object recognition information within the hop distance, and leaf recognition information. The memory 430 stores the analysis information transferred from the data analyzing unit 420.

FIG. 7 is a flow chart illustrating an example of a method for storing graph data. The method performed by the apparatus for managing graph data 310 will be explained in detail below.

Referring to FIG. 7, in S710, the apparatus for managing graph data 310 receives data from an external interface.

In S720, the apparatus for managing graph data 310 determines whether the received data is a graph data form.

In an embodiment, the apparatus for managing graph data 310 determines whether the received data is graph data which can be processable in the apparatus for managing graph data 310.

In S730, the apparatus for managing graph data 310 converts the data into graph data.

In an embodiment, the apparatus for managing graph data 310 converts the inputted data to graph data which can be processable in the apparatus for managing graph data 310.

In S740, the apparatus for managing graph data 310 analyzes the graph data to extract analysis information including relationship therebetween.

In an embodiment, the apparatus for managing graph data 310 determines relationship based on hop distance between the graph data.

In S750, the apparatus for managing graph data 310 determines storage location where the graph data is to be stored based on the analysis information including relationship therebetween.

In an embodiment, the apparatus for managing graph data 310 may determine that the graph data within a predetermined hop distance has high degree of relationship.

In an embodiment, the apparatus for managing graph data 310 may determine a storage location to store the graph data having high degree of relationship in physically one storing device.

In S760, the apparatus for managing graph data 310 generates keys including index information to search the graph data stored in the database.

In S780, the apparatus for managing graph data 310 stores the graph data in the database.

FIG. 8 is a flow chart illustrating an example of a method for searching graph data. The method performed by the apparatus for managing graph data 310 will be explained below.

Referring to FIG. 8, in S810, the apparatus for managing graph data 310 receives a query from an external interface.

In S820, the apparatus for managing graph data 310 performs SQL parsing for the received query.

In S830, the apparatus for managing graph data 310 analyzes the parsed SQL to search a result value corresponding to the query.

In S840, the apparatus for managing graph data 310 generates keys to search graph data based on the SQL analysis result from the database.

In S850, the apparatus for managing graph data 310 searches the graph data based on the key from the database.

In S860, the apparatus for managing graph data 310 returns the graph data searched from the database as a result value for the query.

FIG. 9 to FIG. 11 are diagrams illustrating examples of tables of graph data which is stored in databases.

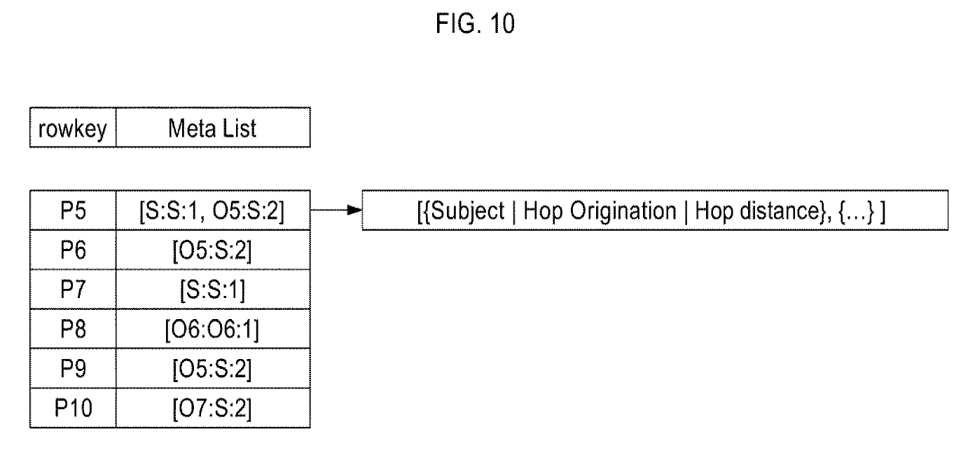

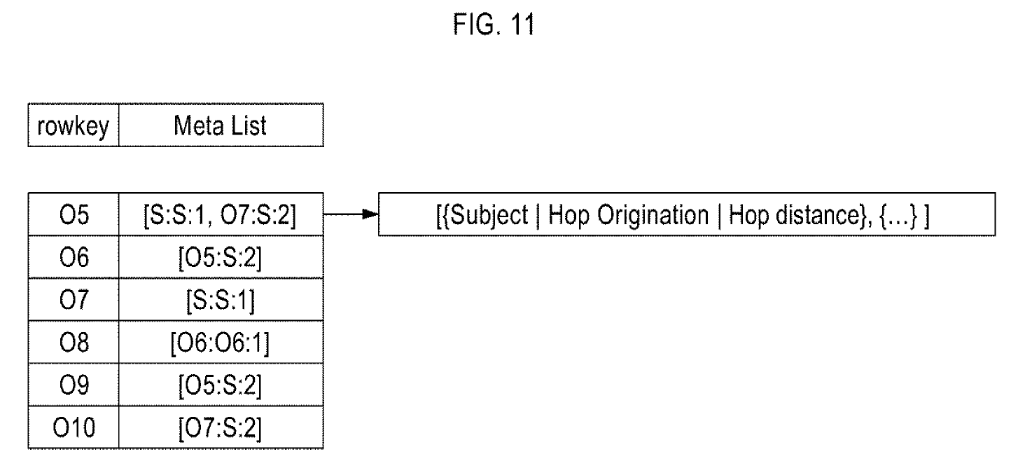

FIG. 12 is a diagram illustrating an example of searching graph data. More particularly, each key value is calculated in accordance with a defined key calculation method. A part or a set of data is searched by combining the entire or a part of key values using functions provided by Hbase. Query examples shown in FIG. 12 illustrate searching data of a select clause through data in a condition clause (where clause). Several forms of condition clauses may be included in SQL as illustrated. It searches first the table in FIG. 10 or FIG. 11 in order to search the table of FIG. 9 from the data in the condition clauses. The data to be searched from the table of FIG. 10 or FIG. 11 is used to calculate a key value to search the table of FIG. 9. The table of FIG. 10 and FIG. 11 may be searched using key values of P and O and includes hop origination information and hop distance information representing Subject values of graph data corresponding to the P and the O and origination subject within the hope distance. Accordingly, the key value to search the table of FIG. 9 may be generated using the information obtained thereby. Rowkey values calculated in the above examples may be used to search all data corresponding to a part of combined key values and key values combined using null.

Accordingly, the exemplary embodiment of the present disclosure can be implemented by the method which the computer is implemented or in non-volatile computer recording media stored in computer executable instructions. The instructions can perform the method according to at least one embodiment of the present disclosure when they are executed by a processor. The computer readable medium may include a program instruction, a data file and a data structure or a combination of one or more of these.

The program instruction recorded in the computer readable medium may be specially designed for the present disclosure or generally known in the art to be available for use. Examples of the computer readable recording medium include a hardware device constructed to store and execute a program instruction, for example, magnetic media such as hard disks, floppy disks, and magnetic tapes, optical media such as CD-ROMs, and DVDs, and magneto-optical media such as floptical disks, read-only memories (ROMs), random access memories (RAMs), and flash memories. In addition, the above described medium may be a transmission medium such as light including a carrier wave transmitting a signal specifying a program instruction and a data structure, a metal line and a wave guide. The program instruction may include a machine code made by a compiler, and a high-level language executable by a computer through an interpreter. The above described hardware device may be constructed to operate as one or more software modules to perform the operation of the present disclosure, and vice versa.

While it has been described with reference to particular embodiments, it is to be appreciated that various changes and modifications may be made by those skilled in the art without departing from the spirit and scope of the embodiment herein, as defined by the appended claims and their equivalents. Accordingly, examples described herein are only for explanation and there is no intention to limit the disclosure. The scope of the present disclosure should be interpreted by the following claims and it should be interpreted that all spirits equivalent to the following claims fall with the scope of the present disclosure.

What is claimed is:

1. An apparatus for managing graph data comprising:
a data analyzing unit configured to analyze a graph data set to extract analysis information comprising relationship between graph data;
a memory configured to store the analysis information; and
a scheduler configured to determine a storage location where the graph data is to be stored in a database based on the analysis information.

2. The apparatus of claim 1, wherein the scheduler determines a storage location to store the graph data within a range of threshold relationship in physically one storing device.

3. The apparatus of claim 1, wherein the relationship is determined based on hop distance between graph data.

4. The apparatus of claim 1, further comprising a data pre-processing unit configured to convert input data to graph data.

5. The apparatus of claim 1, further comprising a key calculating unit configured to generate a key comprising index information to search the graph data stored in the database.

6. The apparatus of claim 1, further comprising a data searching unit configured to return a result value by searching the graph data stored in the database when a query is inputted.

7.The apparatus of claim 1, wherein the graph data is RDF-typed data.

8. The apparatus of claim 7, wherein the RDF type is a triple structure of a subject, a predicate and an object, and
wherein the database stores the graph data in a subject-table, a predicate-table and an object-table.

9. The apparatus of claim 5, further comprising a searching unit configured to search the graph data corresponding to a query from the database based on the key to return a result value when the query is inputted.

10. The apparatus of claim 6, wherein the data searching unit comprises a query analyzing unit configured to parse the inputted query in SQL and analyze the parsed SQL.

11. A method for managing graph data comprising:
analyzing a graph data set and extracting analysis information comprising relationship between graph data;
storing the analysis information in a memory; and
determining a storage location where the graph data is to be stored in a database based on the analysis information.

12. The method of claim 11, wherein the determining a storage location comprises determining a storage location to store the graph data within a range of threshold relationship in physically one storing device.

13. The method of claim 11, wherein the relationship is determined based on hop distance between graph data.

14. The method of claim 11, further comprising converting input data to graph data.

15. The method of claim 11, further comprising generating a key comprisng index information to search the graph data stored in the database.

16. The method of claim 11, further comprising searching the graph data stored in the database to return a result value when a query is inputted.

17. The method of claim 11, wherein the graph data is RDF-typed data.

18. The method of claim 17, wherein the RDF type is a triple structure of a subject, a predicate and an object, and
wherein the database stores the graph data in a subject-table, a predicate-table and an object-table.

19. The method of claim 15, further comprising searching the graph data corresponding to a query from the database based on the key to return a result value when the query is inputted.

20. The method of claim 16, wherein the searching unit comprises a query analyzing unit configured to parse the inputted query in SQL and analyze the parsed SQL.
